(19) United States
(12) Patent Application Publication
(10) Pub. No.: US 2006/0117225 A1
(43) Pub. Date: Jun. 1, 2006

(54) Electronic device with debugging function and method thereof

(75) Inventors: Chih-Hao Hsin, Taipei City (TW); Chia-Shang Yuan, Taichung City (TW)

Correspondence Address: REED SMITH LLP, 3110 FAIRVIEW PARK DRIVE, SUITE 1400, FALLS CHURCH, VA, 22042, US

(73) Assignee: BenQ Corporation

(21) Appl. No.: 11/269,853

(22) Filed: Nov. 9, 2005

(30) Foreign Application Priority Data
Nov. 11, 2004 (TW) 93134470

(51) Int. Cl. G06F 11/00

(52) U.S. Cl. 714/38

(57) ABSTRACT

An electronic device including a memory, an executable file and an interface is provided. When the executable file is executed, a map file is generated and stored in the memory. The map file includes at least one parameter and at least one memory address; the at least one parameter and the at least one memory address correspond to at least one function or at least one variable in the executable file. The electronic device is operable with a debugging means. The interface, connected to the memory, allows the debugging means to access the memory via the interface. The electronic device of the present invention further includes a monitoring device that updates the map file data in the debugging means by periodically sending the map file back to the debugging means.

### CROSS REFERENCE TO RELATED APPLICATIONS

This application claims priority of Taiwan Patent Application Serial No. 093134470 entitled “AN ELECTRONIC DEVICE WITH A DEBUGGING FUNCTION AND THE METHOD THEREOF”, filed on Nov. 11, 2004.

### FIELD OF THE INVENTION

The present invention relates to an electronic device operable with a debugging device through an interface connected to the debugging device.

### BACKGROUND OF THE INVENTION

The conventional debugging device and method for debugging an electronic device, such as a mobile phone, use a simulator for simulating runtime environment of the mobile phone. The debugging information of the program in simulator is obtained from the test points on the mobile phone, and functions/variables modification instructions are set by utility program. This kind of simulator may find limited errors occurred in the program that pertains to certain conditions. Therefore, it can only detect certain errors of the program.

Another conventional debugging device and method is to retrieve the information inside the mobile phone via software debugging interface and a custom debugging utility designed for the CPU of mobile phone. However, it requires test points preserved on the circuit board in the mobile phone. The debugging utility is required to be electrically directly connected to the test points in the mobile phone during debugging operation, and then instructions are sent to the mobile phone from an external debugging interface for instructing the CPU to collect information of functions or variables during debug process. However, the mobile phone needs to be disassembled first before the debugging operation, which might be displeasing for some customers. Further, it is not easy to reproduce all kinds of possible errors, for example, some errors occurred only after a long-time execution. And the memory will be reset after the mobile phone is powered off, which causes the special error information vanish, and the debugging operation becomes more difficult.

Therefore, it is advantageous to have a debugging device and method for debugging a mobile phone in real-time operation without actually disassembling the mobile phone.

### SUMMARY OF THE INVENTION

It is one aspect of the present invention to provide a debugging device connected to an electronic device via an interface for debugging without disassembling the electronic device. The present invention includes a memory, an executable file and an interface. When the executable file is executed, a map file is generated and stored in the memory. The map file includes at least one parameter and at least one memory address; the at least one parameter and the at least one memory address correspond to at least one function or at least one variable in the executable file. The electronic device is operable with the debugging device. The interface, connected to the memory, allows the electronic device to receive read/write instructions from the debugging device. The electronic device reads/writes a value stored in a predetermined memory address segment of the memory according to the read/write instructions.

It is another aspect of the present invention to provide an electronic device including a monitoring device that updates the map file in the debugging device by periodically sending the map file back to the debugging device.

In is further another aspect of the present invention to provide a method for debugging an electronic device. The method includes the following steps. The electronic device executes an executable file and generates a map file. The electronic device is connected to a debugging device. The debugging device accesses the map file to debug the executable file. When the electronic device executes the executable file, the interface passes the electronic device read/write instructions from the debugging device. The electronic device reads/writes a value stored in a predetermined memory address segment of the memory according to the read/write instructions.

It is yet another aspect of the invention to provide a method for debugging an electronic device, including the electronic device periodically updates data of the memory, and automatically transmits the data to the debugging device at a predetermined time.

### BRIEF DESCRIPTION OF THE DRAWINGS

FIG. 1 is a block diagram illustrating an electronic device in accordance with an embodiment of the present invention; and

FIG. 2 is a flowchart illustrating a method for debugging an electronic device in accordance with the present invention.

### DETAILED DESCRIPTION OF THE INVENTION

The present invention provides an electronic device operable with a debugging device via an interface for debugging operations. The electronic devices includes, but not limited to, a mobile phone, a personal digital assistance, a handheld computer, and the likes. The electronic device, operable with an external debugging device via an interface, may be debugged without actually de-assembling the electronic device.

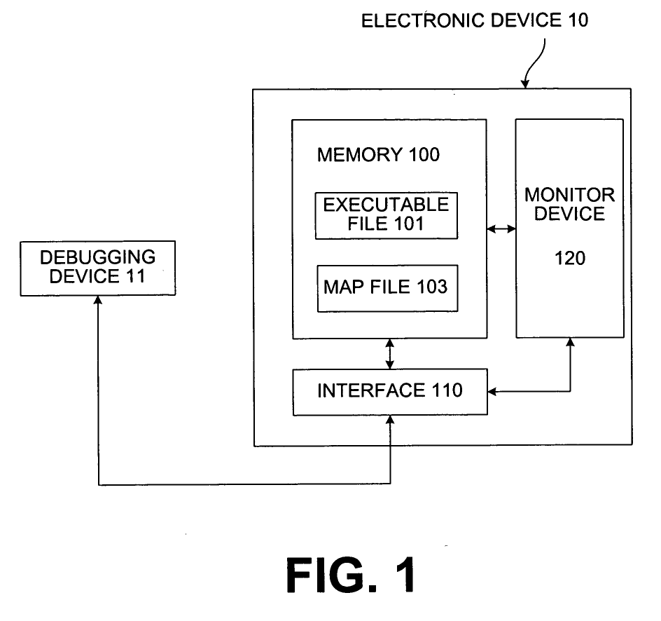

Referring to FIG. 1, the electronic device 10 includes a memory 100, an executable file 101, and an interface 110 in accordance with an embodiment of the present invention. When the executable file 101 is executed, a map file 103 is generated and stored in the memory 100. The source codes are compiled by a computer to generate executable codes, i.e. the executable file 101. A map file 103, stored in the memory 100, is concurrently generated with the executable file 101. The map file 103 records functions and variables in the source code, and the memory addresses of functions/variables corresponding to the executable file 101. The executable file 101 is executed with the functions/variable in the map file 103. The map file 103 includes a plurality of records, each having four fields, e.g., a function name (or variable name or its ID code), a memory address, a data type, and a data length. The interface 110, connected to the memory 100, may be a software application interface for inputting information to the electronic device 10 by a user. The electronic device 10 is operable with an external debugging device 11 when the user initiates the debugging operation. The debugging device 11 accesses the memory 100 via the interface 110. In a preferred embodiment, during the execution of file 101, the electronic device 10 receives a read instruction from the debugging device 11. The electronic device 10 reads a value (or the whole map file 103) from a predetermined memory address segment of the memory according to the read instruction, and then transmits the value (or the whole map file 103) to the debugging device 11. If the debugger (e.g. an engineer) considers that the value should be modified, the electronic device 10 receives a write instruction from the debugger via the debugging device 11. The electronic device 10 then writes a value into the predetermined memory address segment of the memory as the function or as the variable. After the modification, the executable file 101 continues its design function with new value, and the debugging operation proceeds with the result of execution being monitored. In one embodiment of the present invention, the electronic device 10 is a mobile phone, and the interface 110 is a hardware connecting port electrically coupled to the memory 100 for transmitting the information from the debugging device 11 into the memory 100. In this embodiment, the interface 110 is a Universal Serial Bus connector connecting to a debugging device 11 in a computer (not shown). In another embodiment of the present invention, interface 110 is a RS232 connector connecting to a debugging device 11 in a computer. However, the example is provided for illustrative purpose and should not be considered as a limitation of the present invention.

In another embodiment, the electronic device 10 further includes a monitoring device 120 for periodically monitoring data of the map file 103. The monitoring device 120 receives an instruction indicating the memory address needed to be monitored, the size of the monitored data, the frequency of monitoring, and so on. The monitoring device 120 may register with a time counter (not shown in figures) for periodically updating data of the map file 103, and then periodically transmits the map file 103 to the debugging device 11.

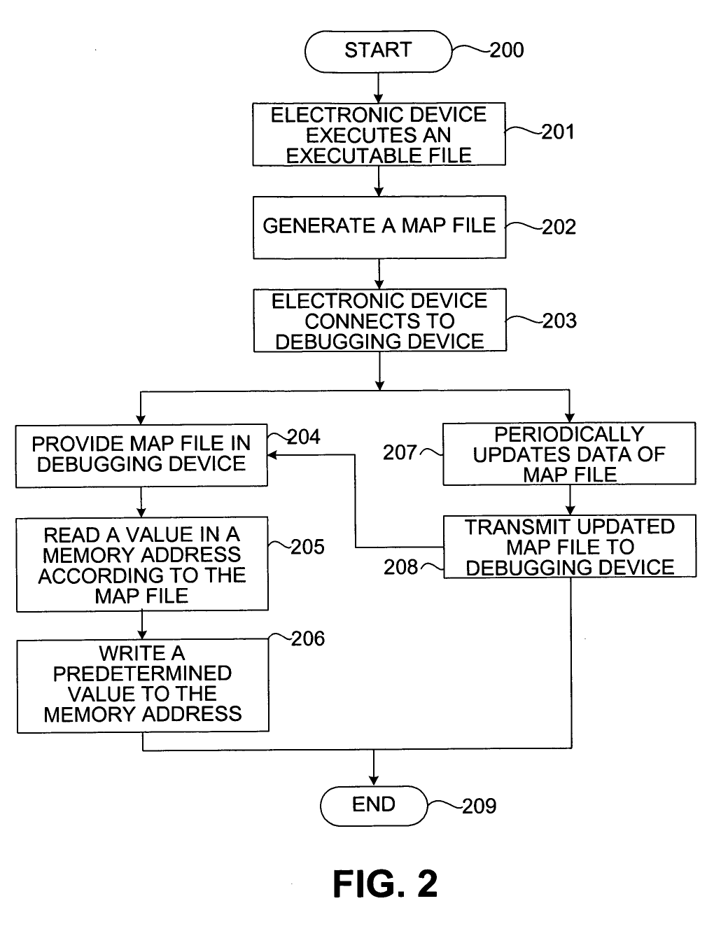

FIG. 2 is a flowchart illustrating a method for debugging an electronic device in accordance with the present invention. The method for debugging the electronic device begins from step 200. In step 201, the electronic device 10 executes an executable file 101. In step 202, a map file is generated. In step 203, the electronic device 10 is connected to a debugging device 11. In this embodiment, the electronic device 10 is connected to a debugging device 11 in a computer via a Universal Serial Bus connector. In another embodiment, the electronic device 10 is connected to a debugging device 11 in a computer via a RS232 connector. In step 204, the map file 103 is provided in the debugging device 11 to be analyzed by a debugger (e.g. an engineer). After the analysis, the user operates the debugging device 11 to read a suspicious memory address in the memory 100 (step 205). In step 205, the electronic device 10 reads a value stored in a predetermined memory address segment of the memory 100 in responding to a read instruction from the debugging device 11, and then transmits the value to the debugging device 11. If the user considers that the value may be wrong, a predetermined value is written into the predetermined memory address in memory 100 (step 206). In step 206, the electronic device 10 writes a predetermined value into the predetermined memory address segment of the memory 100 in responding to a write instruction from the debugging device 11, and the executable file 101 is executed with the predetermined value as a part of the executed file 101.

The variation of certain data in memory may also be continuously monitored in order to understand the operations in the electronic device. Hence, the method for debugging the electronic device further includes a monitoring step in another embodiment of the present invention. After the electronic device 10 is connected to the debugging device 11 (step 203), the data of map file is periodically updated in step 207. In step 207, the electronic device 10 receives a monitor instruction indicating the memory address needed to be monitored, the size of the monitored data, the frequency of monitoring, and so on. Afterward, a time counter is registered for counting the interval time between monitoring. In step 208, the electronic device 10 transmits the updated map file 103 to the debugging device 11 via a Universal Serial Bus connector, a RS232 connector, or the likes. The method is either returned to step 204 for further analysis or ended at step 209.

The above description sets forth various preferred embodiments of the invention only, and is not intended to limit the scope, applicability, or configuration of the invention in any way. Rather, various changes may be made in the function and arrangement of the elements described in these embodiments without departing from the spirit and scope of the invention. Thus, the protected scope of the present invention is as set forth in the appended claims.

What is claimed is:

1. An electronic device operable with a debugging means, comprising:
a memory;
an executable file generating a map file stored in the memory when the executable file is executed, the map file including at least a name and at least a memory address, the name and the memory address corresponding to at least a function or at least a variable within the executable file; and
an interface, connected to the memory, allowing the debugging means to access the memory via the interface.

2. The electronic device according to claim 1, further comprising a monitoring device periodically updating data of the map file.

3. The electronic device according to claim 2, wherein the monitoring device periodically transmits the map file to the debugging means.

4. The electronic device according to claim 1, wherein the debugging means is installed in a computer electrically coupled to the electronic device via a Universal Serial Bus (USB).

5. The electronic device according to claim 1, wherein the debugging means is installed in a computer electrically coupled to the electronic device via a RS232 connector.

6. The electronic device according to claim 1, wherein the electronic device is capable of receiving a read instruction from the debugging means when the executable file is executed, and the electronic device reads a value stored in a predetermined memory address segment in the memory in response to the read instruction, and the electronic device transmits the value to the debugging means.

7. The electronic device according to claim 1, wherein the electronic device is capable of receiving a write instruction from the debugging means when the executable file is executed, and the electronic device writes a predetermined value into a predetermined memory address segment in the memory in response to the write instruction.

8. The electronic device according to claim 1, wherein the debugging means reads the map file in the memory via the interface.

9. The electronic device according to claim 1, wherein the debugging means writes a debugging map file in the memory via the interface.

10. A method for debugging an electronic device, the method comprising the steps of:
the electronic device executing an executable file and generating a map file, the map file including at least a name and at least a memory address, the name and the memory address corresponding to at least a function or at least a variable within the executable file; and
connecting the electronic device to a debugging means; and
the debugging means accessing the map file to debug the executable file.

11. The method according to claim 10, further comprising a step of periodically updating data of the map file.

12. The method according to claim 11, further comprising a step of automatically transmitting the data to the debugging means at a predetermined time.

13. The method according to claim 10, wherein the debugging means is installed in a computer electrically coupled to the electronic device via a Universal Serial Bus (USB).

14. The method according to claim 10, wherein the debugging means is installed in a computer electrically coupled to the electronic device via a RS232 connector.

15. The method according to claim 10, wherein the electronic device is capable of receiving a read instruction from the debugging means when the executable file is executed, and the electronic device reads a value stored in a predetermined memory address segment in the memory in response to the read instruction, and the electronic device transmits the value to the debugging means.

16. The method according to claim 10, wherein the electronic device is capable of receiving a write instruction from the debugging means when the executable file is executed, and the electronic device writes a predetermined value into a predetermined memory address segment in the memory in response to the write instruction and executes the executable file incorporating the predetermined value.
